(19) United States
(12) Patent Application Publication
(10) Pub. No.: US 2016/0285730 A1
(43) Pub. Date: Sep. 29, 2016

(54) APPARATUS AND METHOD FOR MEASURING A BANDWIDTH FOR DATA TRANSMISSION BETWEEN COMMUNICATION DEVICES

(71) Applicant: FUJITSU LIMITED, Kawasaki-shi (JP)

(72) Inventors: Naoyoshi Ohkawa, Kawasaki (JP); Yuji Nomura, Kawasaki (JP); Fumiyuki Iizuka, Kawasaki (JP); Sumiyo Okada, Kawasaki (JP)

(73) Assignee: FUJITSU LIMITED, Kawasaki-shi (JP)

(21) Appl. No.: 15/055,021

(22) Filed: Feb. 26, 2016

(30) Foreign Application Priority Data
Mar. 25, 2015 (JP) 2015-063354

(51) Int. Cl. H04L 12/26

(52) U.S. Cl. CPC H04L 43/0894; H04L 43/16

(57) ABSTRACT

An apparatus acquires a packet transmitted between a transmission-terminal and a reception-terminal, and stores the acquired packet in association with a time at which the packet has been acquired. When a first bandwidth of data packets transmitted by the transmission-terminal during a time-period from acquisition of a first ACK-packet transmitted by the reception-terminal to acquisition of a second ACK-packet transmitted by the reception-terminal subsequently to the first ACK-packet, is smaller than a second bandwidth or greater than a third bandwidth, the apparatus determines the second ACK-packet to be a packet not desired to measure a bandwidth, where the second bandwidth is calculated using an acquisition interval between first and second data packets transmitted respectively after waiting for the first and second ACK-packets, and the third bandwidth is calculated using an acquisition interval between two adjacent data packets including a data packet transmitted without waiting for an ACK-packet.

### CROSS-REFERENCE TO RELATED APPLICATION

This application is based upon and claims the benefit of priority of the prior Japanese Patent Application No. 2015-063354, filed on Mar. 25, 2015, the entire contents of which are incorporated herein by reference.

### FIELD

The embodiment discussed herein relates to apparatus and method for measuring a bandwidth for data transmission between communication devices.

### BACKGROUND

There is a case in which a client terminal downloads data from a server. Generally, a network bandwidth on the side of the client terminal is smaller than a network bandwidth on the side of the server. Therefore, it is desired to predict download completion time by estimating the network bandwidth on the side of the client terminal.

In recent years, a monitoring device has been installed in the vicinity of the side of the server, and the network bandwidth between the server and the client terminal is estimated based on packets which are transmitted and received between the server and the client terminal.

Japanese Laid-Open Patent Publication No. 2005-130298, Japanese Laid-Open Patent Publication No. 2006-20302, Japanese Laid-Open Patent Publication No. 2006-279283, Japanese Laid-Open Patent Publication No. 2007-266756, and Japanese Laid-Open Patent Publication No. 2015-035709 are examples of related art.

### SUMMARY

According to an aspect of the invention, an apparatus acquires a packet which is transmitted between a transmission terminal and a reception terminal, at any spot of a network between the transmission terminal and the reception terminal, and stores the acquired packet in association with a time at which the packet has been acquired. When a first bandwidth of data packets which are transmitted by the transmission terminal during a time-period from acquisition of a first acknowledgement (ACK)-packet transmitted by the reception terminal to acquisition of a second ACK-packet that is transmitted by the reception terminal subsequently to the first ACK-packet, is smaller than a second bandwidth or greater than a third bandwidth, the apparatus determines the second ACK-packet to be a packet which is not desired to measure a bandwidth, where the second bandwidth is calculated using an acquisition interval between first and second data packets that are transmitted respectively after waiting for the first ACK-packet and the second ACK-packet, and the third bandwidth is calculated using an acquisition interval between two adjacent data packets that includes a data packet transmitted without waiting for an ACK-packet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a functional configuration of a packet analysis device, according to an embodiment;

FIG. 2A is a diagram illustrating an example of a problem of estimating a bandwidth by using ACKs, according to an embodiment;

FIG. 2B is a diagram illustrating an example of a problem of estimating the bandwidth by using ACKs, according to an embodiment;

FIG. 3A is a diagram illustrating an example of a method of calculating a threshold by using a cross traffic determination unit, according to an embodiment;

FIG. 3B is a diagram illustrating an example of a method of calculating a threshold by using a cross traffic determination unit, according to an embodiment;

FIG. 4 is a diagram illustrating an example of a data structure of a connection management table, according to an embodiment;

FIG. 5 is a diagram illustrating an example of a data structure of a DATA table, according to an embodiment;

FIG. 6 is a diagram illustrating an example of a data structure of an ACK table, according to an embodiment;

FIG. 7 is a diagram illustrating an example of a data structure of a threshold table, according to an embodiment;

FIG. 8 is a diagram illustrating an example of a data structure of a statistical information table, according to an embodiment;

FIG. 9A is a diagram illustrating an example of an operational flowchart for a packet analysis process, according to an embodiment;

FIG. 9B is a diagram illustrating an example of an operational flowchart for a process which is performed when a data packet is received, according to an embodiment;

FIG. 9C is a diagram illustrating an example of an operational flowchart for a process which is performed when an ACK packet is received, according to an embodiment;

FIG. 10 is a diagram illustrating an example of a packet analysis process when an ACK interval is lengthened, according to an embodiment;

FIG. 11 is a diagram illustrating an example of a packet analysis process when an ACK interval is shortened, according to an embodiment; and

FIG. 12 is a diagram illustrating an example of a configuration of a computer which executes a packet analysis program, according to an embodiment.

### DESCRIPTION OF EMBODIMENT

However, in the related art, there is a problem in that it is difficult to accurately measure the network bandwidth on the side of the client terminal. That is, when cross traffic occurs between the monitoring device and the client terminal, the measurement of the network bandwidth on the side of the client terminal is affected, and thus it is difficult to perform accurate measurement. The cross traffic refers to another traffic which flows over the network. When the cross traffic occurs, delay occurs in communication, and thus the measurement of the network bandwidth on the side of the client terminal is affected.

It is desirable to more accurately measure the network bandwidth of a client terminal.

Hereinafter, an embodiment of a packet analysis program, a packet analysis device, and a packet analysis method which are disclosed in the application will be described in detail based on the accompanying drawings. Meanwhile, the disclosed technology is not limited to the embodiment.

### Embodiment s

### Configuration of Packet Analysis Device According to Embodiment

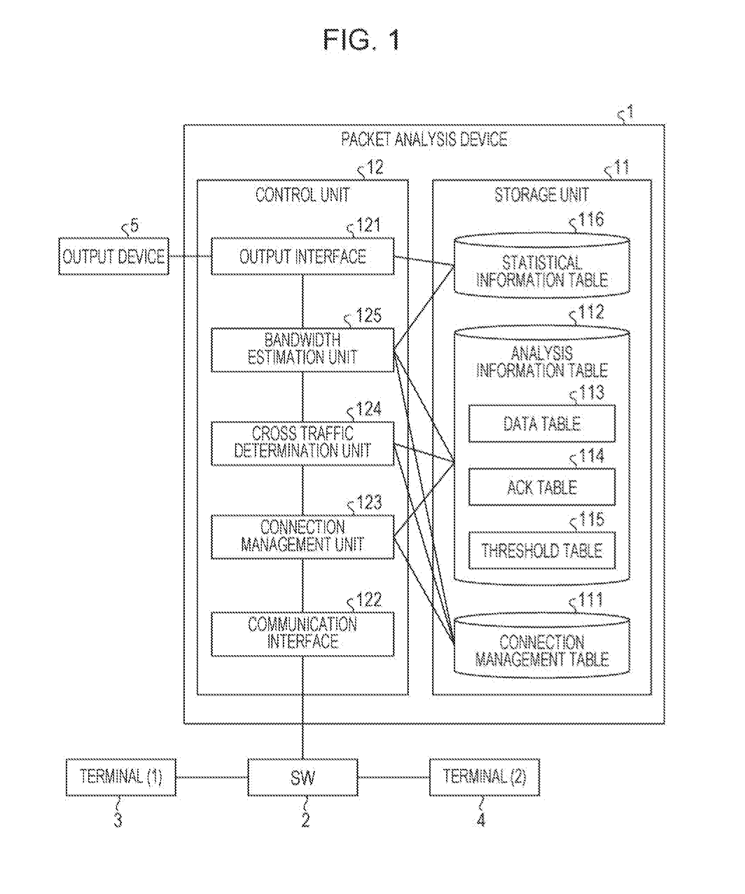

FIG. 1 is a view illustrating the functional configuration of a packet analysis device according to an embodiment. As illustrated in FIG. 1, a packet analysis device 1 acquires a packet which is communicated between a terminal 3 and a terminal 4 through an SW 2, and passively diagnoses a network bandwidth. The passive diagnosis is a diagnosis method of diagnosing the network bandwidth while a packet which flows through a network is set to a measurement target. Meanwhile, the diagnosis method of diagnosing the network bandwidth includes active diagnosis in addition to passive diagnosis. In the embodiment, the passive diagnosis is applied. Hereinafter, description will be given while it is assumed that the terminal 3 is a reception-side terminal and the terminal 4 is a transmission-side terminal.

The packet analysis device 1 estimates the network bandwidth between the terminals 3 and 4 based on the transfer quantity of data packets (hereinafter, referred to as DATA), which are transmitted between an ACK packet (hereinafter, referred to as an ACK) and an ACK, and arrival intervals between the ACKs. That is, when the reception-side terminal 3 replies the ACK, the reception-side terminal 3 replies the ACK immediately after the DATA is received. Therefore, when there is no bottleneck in a network due to cross traffic or the like, DATA intervals are equal to ACK intervals. Therefore, the packet analysis device 1 may estimate a reception-side network bandwidth based on the transfer quantity of DATA, which is transmitted between the ACKs, and the arrival interval between the ACKs as in Equation (1). The transfer quantity of DATA which is transmitted between the ACKs is substituted for a packet size in Equation (1). In addition, the arrival interval between the ACKs is substituted for the interval between packets in Equation (1).

network bandwidth=8×packet size/interval between packets Equation (1)

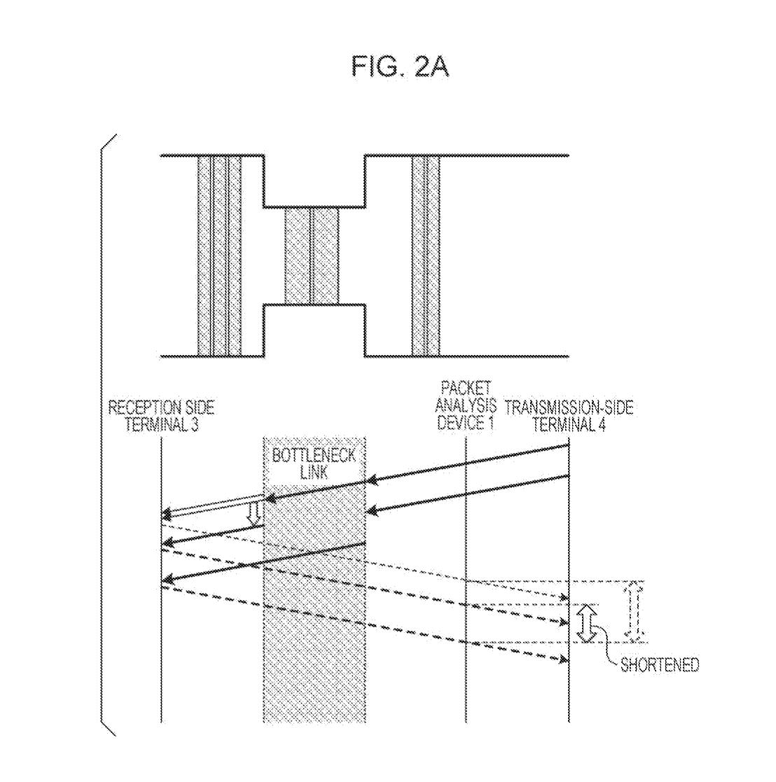

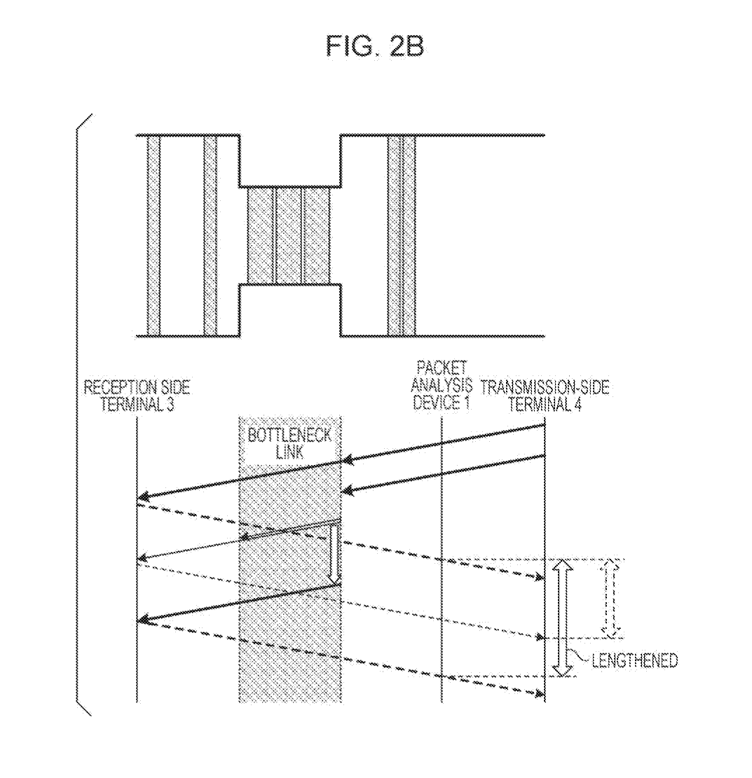

However, there is a problem when the bandwidth is estimated using the ACKs. Here, a problem of estimating a bandwidth using the ACKs will be described with reference to FIGS. 2A and 2B. FIGS. 2A and 2B are views illustrating the problem of estimating the bandwidth using the ACKs.

As illustrated in FIGS. 2A and 2B, when there is a bottleneck in a network, the arrival interval between the ACKs is changed. FIG. 2A illustrates a case in which DATA, which is transmitted earlier from the transmission-side terminal 4, is affected by cross traffic. FIG. 2B illustrates a case in which DATA, which is transmitted later from the transmission-side terminal 4, is affected by cross traffic.

As illustrated in FIG. 2A, when the DATA, which is transmitted earlier from the transmission-side terminal 4, is affected by cross traffic, the arrival interval between an ACK for the DATA and an ACK for the subsequent DATA is shortened in the packet analysis device 1, compared to a case of not being affected by cross traffic. That is, the packet analysis device 1 estimates the network bandwidth to be wide, compared to a case of not being affected by cross traffic.

As illustrated in FIG. 2B, when the DATA which is subsequently transmitted from the transmission-side terminal 4 is affected by cross traffic, the arrival interval between the ACK for the DATA and the ACK for the previous DATA is lengthened in the packet analysis device 1, compared to a case of not being affected by cross traffic. That is, the packet analysis device 1 estimates that the network bandwidth is narrow, compared to a case of not being affected by cross traffic.

Therefore, the packet analysis device 1 is demanded to estimate the network bandwidth after removing the ACK which is affected by the cross traffic as the ACK which is not desired to estimate the bandwidth.

Here, although the packet analysis device 1 according to the embodiment estimates a network bandwidth, based on ACKs, the packet analysis device 1 calculates a threshold used to determine an ACK which is not desired to estimate the bandwidth, based on DATA. The threshold is calculated based on the DATA due to two reasons below. A first reason is that DATA transmission timing depends on ACKs. That is, the transmission-side terminal 4 recognizes the arrival of DATA transmitted in advance by receiving the ACK and then transmits subsequent DATA. A second reason is that the arrival interval between the DATA is stable compared to the arrival interval between the ACKs. That is, the sizes of the DATA are greater than those of the ACKs and the actions of the DATA are stable compared to those of the ACKs. A detailed threshold calculation method will be described later.

Returning to FIG. 1, the terminals 3 and 4, for example, perform communication on the network by using transmission control protocol (TCP).

Here, an example of the feature of the communication function of the TCP will be described. When the reception-side terminal 4 receives a data packet, the reception-side terminal 4 transmits an ACK to the transmission-side terminal 3 after setting the sequence number of data, which is scheduled to be subsequently sent, to the acknowledgment number of the ACK, based on the sequence number and the data size of the data. The transmission-side terminal 3 receives the ACK, recognizes the acknowledgment number of the received ACK, and then transmits a subsequent data packet.

However, communication efficiency is bad when the transmission-side terminal 3 receives the data packets one by one and performs recognition and transmission. Here, in the TCP, “window control” is performed. In the window control, a plurality of data packets are consecutively transmitted without receiving the data packets one by one and performing recognition and transmission by the transmission-side terminal 3. That is, the transmission-side terminal 3 manages the plurality of data packets in a unit called a window size, and consecutively transmits the data packets without waiting for the acknowledgment number of the ACK. The communication efficiency is improved through the window control. Meanwhile, the data packets, which are consecutively transmitted through the window control, are called “consecutive packets”. Meanwhile, it is possible to specify the number of consecutive packets by using, for example, contents disclosed in Japanese Laid-Open Patent Publication No. 2015-035709.

The packet analysis device 1 includes a storage unit 11 and a control unit 12.

The storage unit 11 corresponds to a storage device including, for example, a nonvolatile semiconductor memory element such as a flash memory or a ferroelectric random access memory (FRAM, registered trademark). The storage unit 11 includes a connection management table 111, an analysis information table 112, and a statistical information table 116. The analysis information table 112 includes a DATA table 113, an ACK table 114, and a threshold table 115.

The connection management table 111 manages the communication information of a transmission source and a destination for each connection. The connection management table 111 is used when the connection of a captured packet is searched.

The analysis information table 112 stores analysis information. The analysis information table 112 is used when the network bandwidth is diagnosed. The analysis information table 112 includes the DATA table 113, the ACK table 114, and the threshold table 115. The DATA table 113 stores, when the data packet is captured, the index number of a data packet, arrival time, and a packet length. The ACK table 114 stores, when the ACK is acquired, the arrival time and the index number of the data packet corresponding to the ACK. The threshold table 115 stores the number of bytes to be used for the threshold, a time interval to be used for the threshold, and a threshold value. Each of the DATA table 113, the ACK table 114, and the threshold table 115 includes a table for each connection.

The statistical information table 116 stores statistical information. The statistical information table 116 stores final statistics for the diagnosis of the network bandwidth. Meanwhile, an example of the data structure of various tables of the storage unit 11 will be described later.

The control unit 12 includes an internal memory in order to store a program, which defines various process procedures, and control data, and executes various processes by using the program and the control data. Further, the control unit 12 corresponds to, for example, an electronic circuit of an integrated circuit such as the application specific integrated circuit (ASIC) and the field programmable gate array (FPGA). In addition, the control unit 12 corresponds to an electronic circuit such as a central processing unit (CPU) or a micro processing unit (MPU). Further, the control unit 12 includes an output interface 121, a communication interface 122, a connection management unit 123, a cross traffic determination unit 124, and a bandwidth estimation unit 125.

The output interface 121 is an interface with an output device 5. For example, the output interface 121 edits statistical information, which is stored in the statistical information table 116, and outputs the edited statistical information to the output device 5.

The communication interface 122 captures packets, which are communicated between the terminal 3 and the terminal 4, via the SW 2. The communication interface 122 delivers the captured packets to the connection management unit 123.

The connection management unit 123 manages the connections of the captured packets. For example, the connection management unit 123 refers to the connection management table 111, and determines whether or not a packet, which has the same connection information as the captured packet, is captured in advance. When it is determined that the packet is not captured in advance, the connection management unit 123 adds the connection information of a currently captured packet to the connection management table 111. In addition, when it is determined that the packet is captured in advance, the connection management unit 123 does nothing. The connection information includes, for example, a connection ID, the IP address of the transmission source, the port number of the transmission source, the IP address of the destination, and the port number of the destination. In addition, when the currently captured packet is an ACK, the connection management unit 123 adds ACK information, which is associated with the connection ID and acquisition time, to the ACK table 114. When the currently captured packet is the DATA, the connection management unit 123 adds DATA information, which is associated with the connection ID and the acquisition time, to the DATA table 113.

The cross traffic determination unit 124 determines an ACK that has been affected by the cross traffic. For example, when DATA, which are transmitted after waiting for an ACK, are captured, the cross traffic determination unit 124 calculates a network bandwidth by using an arrival interval between two pieces of DATA which are respectively transmitted after waiting for the ACK received immediately before and the current ACK. The cross traffic determination unit 124 sets the calculated network bandwidth to the lower-limit threshold in the threshold table 115. As an example, a case is assumed in which the number of consecutive packets is two. The cross traffic determination unit 124 calculates an arrival interval of DATA (hereinafter, also referred to as “a data-arrival interval”) by subtracting an arrival interval between the consecutive packets transmitted between the two ACKs, from an arrival interval between two pieces of DATA which are respectively transmitted after waiting for the ACK received immediately before and the current ACK. The cross traffic determination unit 124 calculates the network bandwidth by substituting the calculated data-arrival interval and the size of the DATA for Equation (1), and sets the calculated network bandwidth to the lower-limit threshold. A reason that the estimated value of the network bandwidth calculated based on the arrival interval between two pieces of DATA, which are respectively transmitted after waiting for ACKs, is set to the lower-limit threshold, is as follows. That is, the estimated value of the network bandwidth calculated based on the arrival interval between the two pieces of DATA, which are respectively transmitted after waiting for the ACKs, becomes lower than that of the reception-side network bandwidth when the arrival interval between the ACKs is normal, and thus the estimated value, which becomes lower, is set to the lower-limit threshold.

When pieces of DATA, which are transmitted without waiting for the ACK, are captured, the cross traffic determination unit 124 calculates a network bandwidth by using an arrival interval between the consecutively transmitted pieces of DATA. The cross traffic determination unit 124 sets the calculated network bandwidth to the upper-limit threshold in the threshold table 115. As an example, a case is assumed in which the number of consecutive packets is two. The cross traffic determination unit 124 calculates the arrival interval between the two pieces of DATA in the consecutive packets. The cross traffic determination unit 124 substitutes the arrival interval between the two pieces of DATA and the size of the DATA for Equation (1), calculates the network bandwidth, and sets the calculated network bandwidth to the upper-limit threshold. A reason that the estimated value of the network bandwidth calculated based on the arrival interval between the consecutively transmitted pieces of DATA is set to the upper-limit threshold is as follows. That is, the network bandwidth, which is calculated based on the arrival interval between the consecutively transmitted pieces of DATA, becomes higher than the reception-side network bandwidth when the arrival interval between the ACKs is normal, and the estimated value, which becomes higher, is set to the upper-limit threshold.

The cross traffic determination unit 124 substitutes the arrival interval between ACKs and the size of DATA between the ACKs for Equation (1), and calculates the network bandwidth. When the network bandwidth, which is calculated using the arrival interval between ACKs, is smaller than the lower-limit threshold, the cross traffic determination unit 124 determines that the ACKs are affected by the cross traffic. That is, the arrival interval between the ACKs is lengthened. When the network bandwidth, which is calculated using the arrival interval between ACKs, is larger than the upper-limit threshold, the cross traffic determination unit 124 determines that the ACKs are affected by the cross traffic. That is, the arrival interval between the ACKs is shortened. When the network bandwidth, which is calculated using the arrival interval between ACKs, is larger than the lower-limit threshold and smaller than the upper-limit threshold, the cross traffic determination unit 124 determines that the ACKs are not affected by the cross traffic.

The bandwidth estimation unit 125 estimates the network bandwidth on the reception-side. For example, the bandwidth estimation unit 125 determines an ACK, which is determined to be an ACK affected by the cross traffic by the cross traffic determination unit 124, as a packet which is not desired to measure the bandwidth, and removes the ACK. The bandwidth estimation unit 125 updates a network bandwidth, which is calculated using the ACK that is determined to be an ACK not affected by cross traffic by the cross traffic determination unit 124, as the network bandwidth of the reception-side terminal 3. In this way, the bandwidth estimation unit 125 removes ACKs affected by the cross traffic, when the network bandwidth of the reception-side terminal 3 is measured, thereby enabling the network bandwidth of the reception-side terminal 3 to be further accurately measured.

[Threshold Calculation Method]

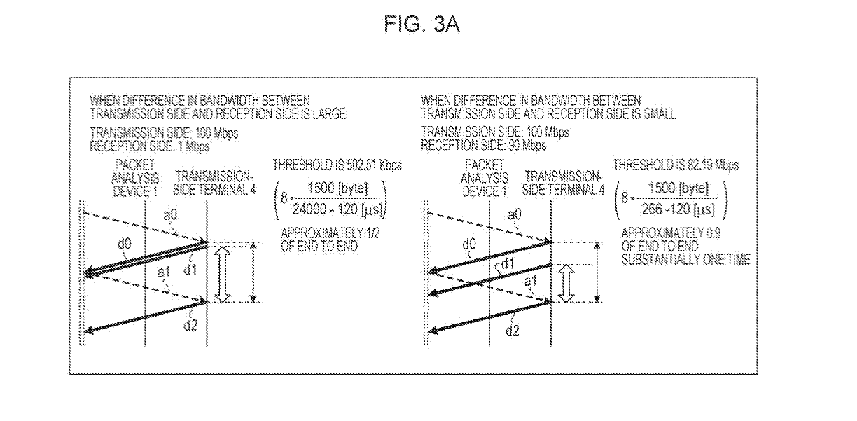

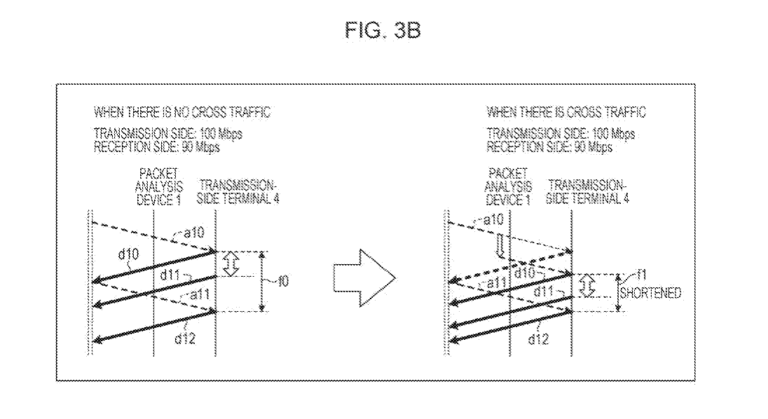

A method of calculating the threshold by the cross traffic determination unit 124 will be described with reference to FIGS. 3A and 3B. FIGS. 3A and 3B are views illustrating a method of calculating the threshold by the cross traffic determination unit according to the embodiment. FIG. 3A is a view illustrating a method of calculating the lower-limit threshold. FIG. 3B is a view illustrating a method of calculating the upper-limit threshold. In the case, it is assumed that the number of consecutive packets is two. It is also assumed that the length of the DATA packet is 1500 bytes.

[Lower-Limit Threshold]

In FIG. 3A, ACK information of ACKs a0 and a1 is stored in the ACK table 114. DATA information of DATA d0 and d1 is stored in the DATA table 113.

As illustrated in the left drawing of FIG. 3A and in the right drawing of FIG. 3A, it is assumed that the DATA d2 is captured. In this case, since the DATA d2 is transmitted after waiting for the ACK a1, the cross traffic determination unit 124 calculates the network bandwidth as follows. That is, the cross traffic determination unit 124 calculates an arrival interval between the DATA d0 and d2 which are respectively transmitted after waiting for the ACK a0 and ACK a1. The cross traffic determination unit 124 calculates a data-arrival interval that is obtained by subtracting, from the calculated arrival interval, an arrival interval between the consecutive packets d0 and d1 transmitted between the ACK a0 and ACK a1. The cross traffic determination unit 124 calculates the network bandwidth by substituting the calculated data-arrival interval and the size of the DATA for Equation (1), and sets the calculated network bandwidth to the lower-limit threshold.

In the left drawing of FIG. 3A, it is assumed that the transmission-side network bandwidth is 100 Mbps (megabytes per second) and the reception-side network bandwidth is 1 Mbps. In this case, when communication is performed using the reception-side network bandwidth, an arrival interval between the DATA d0 and d2 is calculated at 24000 μs (micro seconds). It is assumed that an arrival interval between the consecutive packets d0 and d1 is calculated at 120 μs. In this case, the data-arrival interval of DATA is calculated at (24000−120) μs. Further, the cross traffic determination unit 124 substitutes the calculated data-arrival interval of the DATA for the interval between packets in Equation (1) and substitutes 1500 bytes, which indicates the packet length of the DATA d2, for the packet size in Equation (1), thereby obtaining the network bandwidth. Here, the network bandwidth is calculated at 502.51 Kbps, and it is determined that the calculated network bandwidth is the lower-limit threshold.

In the right drawing of FIG. 3A, it is assumed that the transmission-side network bandwidth is 100 Mbps and the reception-side network bandwidth is 90 Mbps. In this case, when communication is performed using the reception-side network bandwidth, an arrival interval between the DATA d0 and d2 is calculated at 266 μs. It is assumed that an arrival interval between the consecutive packets d0 and d1 is calculated at 120 μs. In this case, an data-arrival interval of DATA is calculated at (266−120) μs. Further, the cross traffic determination unit 124 substitutes the calculated data-arrival interval of DATA for the interval between packets in Equation (1), and substitutes 1500 bytes, which indicates the packet length of the DATA d2, for the packet size in Equation (1), thereby obtaining the network bandwidth. Here, the network bandwidth is calculated at 82.19 Mbps, and it is determined that the calculated network bandwidth is the lower-limit threshold.

Here, the left drawing of FIG. 3A indicates a case in which the difference between the transmission-side network bandwidth and the reception-side network bandwidth is large. In this case, a lower-limit threshold of 502.51 Kbps is approximately 0.5 times a reception-side network bandwidth of 1 Mbps. In addition, the right drawing of FIG. 3A indicates a case in which the difference between the transmission-side network bandwidth and the reception-side network bandwidth is small. In this case, a lower-limit threshold of 82.19 Mbps is approximately 0.9 times a reception-side network bandwidth of 90 Mbps. That is, when the transmission-side terminal 4 replies an ACK to two DATA, the cross traffic determination unit 124 is able to set the network bandwidth (lower-limit threshold), which is calculated based on the data-arrival interval of the DATA, at a size which is approximately one to 0.5 times the reception-side network bandwidth. Therefore, when the reception-side network bandwidth is measured, the cross traffic determination unit 124 is able to filter a numerical value, which is smaller than 0.5 times the reception-side network bandwidth, by using the lower-limit threshold. In other words, the cross traffic determination unit 124 is able to specify an ACK, which is affected by the cross traffic and acquired when the arrival interval between ACKs is lengthened, as an ACK which is not desired to measure the network bandwidth.

[Upper-Limit Threshold]

In FIG. 3B, ACK information of an ACK a10 is stored in the ACK table 114. DATA information of DATA d10 and d11 is stored in the DATA table 113.

In the left drawing of FIG. 3B, it is assumed that the DATA d11 is captured. In this case, since the DATA d11 is transmitted without waiting for the ACK, the cross traffic determination unit 124 calculates a network bandwidth as follows. That is, the cross traffic determination unit 124 calculates the network bandwidth by substituting an arrival interval between the consecutively transmitted DATA d10 and d11 and the size of DATA for Equation (1), and sets the calculated network bandwidth to the upper-limit threshold.

Here, when the ACK a10 is affected by cross traffic as illustrated in the right drawing of FIG. 3B, the arrival interval between the ACKs a10 and a11 is shortened from f0 to f1. In this case, when the reception-side network bandwidth is measured, the cross traffic determination unit 124 is able to filter the measured numerical value larger than the upper-limit threshold of the reception-side network bandwidth by using the upper-limit threshold. In other words, the cross traffic determination unit 124 is able to specify the ACK, which is affected by the cross traffic and acquired when the arrival interval between ACKs is shortened, as an ACK which is not desired to measure the network bandwidth.

[Data Structure of Table]

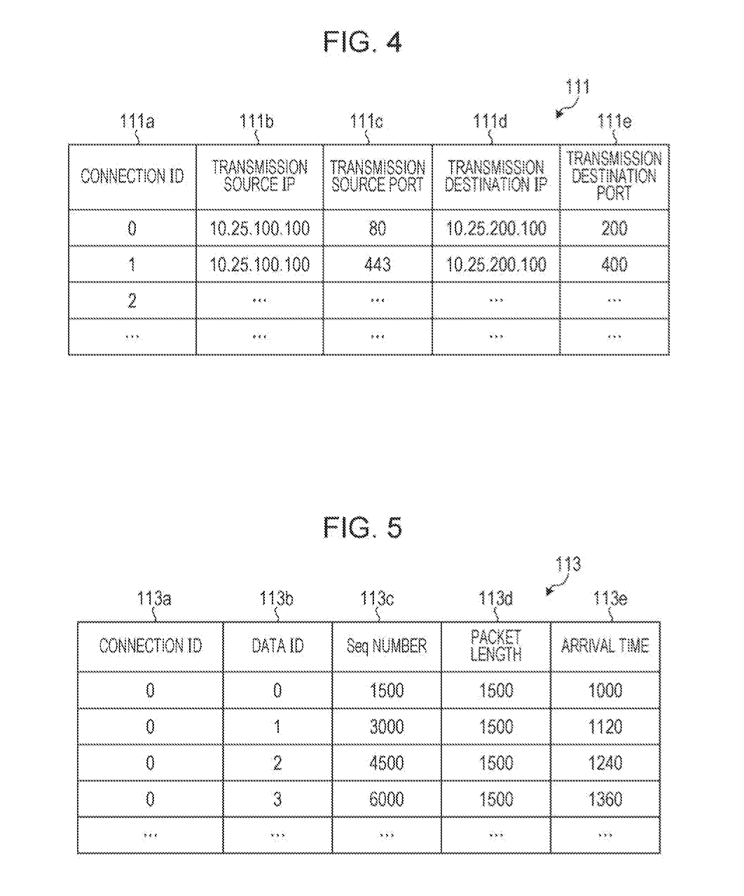

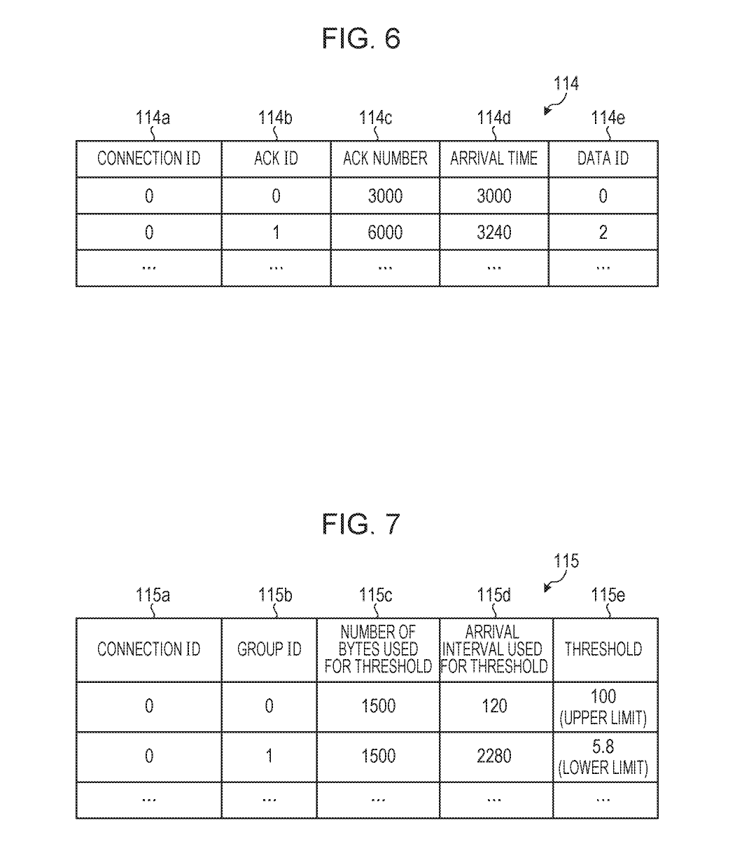

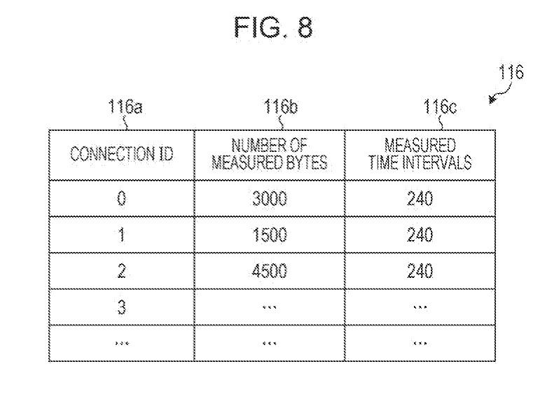

The data structures of various tables which are used in the packet analysis device 1 will be described with reference to FIGS. 4 to 8. FIG. 4 is a view illustrating an example of a data structure of a connection management table. FIG. 5 is a view illustrating an example of a data structure of a DATA table. FIG. 6 is a view illustrating an example of a data structure of an ACK table. FIG. 7 is a view illustrating an example of a data structure of a threshold table. FIG. 8 is a view illustrating an example of a data structure of a statistical information table.

As illustrated in FIG. 4, the connection management table 111 associates a transmission source IP (Internet Protocol) 111b, a transmission source port 111c, a transmission destination IP 111d, and a transmission destination port 111e with the connection ID (identification) 111a, and stores them. The connection ID 111a is an index number which is assigned to each connection. The transmission source IP 111b is the IP address of a transmission source. The transmission source port 111c is the port number of the transmission source in TCP. The transmission destination IP 111d is the IP address of a destination. The transmission destination port 111e is the port number of the destination in the TCP.

As an example, when the connection ID 111a is “0”, it is assumed that “10.25.100.100” is stored as the transmission source IP 111b and “80” is stored as the transmission source port 111c. Further, it is assumed that “10.25.200.100” is stored as the transmission destination IP 111d and “200” is stored as the transmission destination port 111e.

As illustrated in FIG. 5, the DATA table 113 stores a connection ID 113a, a data ID 113b, a Seq number 113c, a packet length 113d, and an arrival time 113e in association with each other. The DATA table 113 is configured to include a table for each connection ID 113a. The connection ID 113a is an index number which is assigned to each connection. The data ID 113b is the index number of DATA. The Seq number 113c is a sequence number of the DATA. The packet length 113d is a length of a DATA packet. The arrival time 113e is a time at which the DATA arrives at the packet analysis device 1.

As an example, when the connection ID 113a is “0” and the data ID 113b is “0”, “1500” is stored as the Seq number 113c, “1500” is stored as the packet length 113d, and “1000” is stored as the arrival time 113e. In addition, when the connection ID 113a is “0” and the data ID 113b is “1”, “3000” is stored as the Seq number 113c, “1500” is stored as the packet length 113d, and “1120” is stored as the arrival time 113e.

As illustrated in FIG. 6, the ACK table 114 stores a connection ID 114a, an ACK ID 114b, an ACK number 114c, an arrival time 114d, and a data ID 114e in association with each other. The ACK table 114 is configured to include a table for each connection ID 114a. The connection ID 114a is an index number which is assigned to each connection. The ACK ID 114b is an index number of an ACK. The ACK number 114c is an ACK number (acknowledgment number) of the ACK. That is, in the ACK number 114c, the Seq number of DATA, which is scheduled to be subsequently received, is set. The arrival time 114d is a time at which the ACK arrives at the packet analysis device 1. The data ID 114e is an index number (data ID) of DATA corresponding to the ACK. That is, the data ID 114e indicates DATA corresponding to the ACK which is illustrated in the ACK ID 114b.

As an example, when the connection ID 114a is “0” and the ACK ID 114b is “0”, “3000” is stored as the ACK number 114c, “3000” is stored as the arrival time 114d, and “0” is stored as the data ID 114e. When the connection ID 114a is “0” and the ACK ID 114b is “1”, “6000” is stored as the ACK number 114c, “3240” is stored as the arrival time 114d, and “2” is stored as the data ID 114e.

As illustrated in FIG. 7, the threshold table 115 stores a connection ID 115a, a group ID 115b, the number 115c of bytes to be used for the threshold, an arrival interval 115d to be used for the threshold, and a threshold 115e, in association with each other. The connection ID 115a is an index number which is assigned to each connection. The group ID 115b is a group number which is assigned to each threshold. That is, the group ID 115b means a group number, which is assigned to the upper-limit threshold that is calculated based on an arrival interval between consecutively transmitted pieces of DATA, and a group number, which is assigned to the lower-limit threshold that is calculated based on an arrival interval between pieces of DATA which are respectively transmitted after waiting for ACKs. The number 115c of bytes to be used for the threshold is the length of a DATA packet which is used when the threshold is calculated. The arrival interval 115d which is used for the threshold is a data-arrival interval of DATA, which is used when the threshold is calculated. The threshold 115e is a threshold calculated based on the number 115c of bytes to be used for the threshold and the data-arrival interval 115d which is used for the threshold.

As an example, when the connection ID 115a is “0”, “0” is stored as the group ID 115b, “1500” is stored as the number 115c of bytes to be used for the threshold, “120” is stored as the data-arrival interval 115d which is used for the threshold, and “100” is stored as the threshold 115e. When the connection ID 115a is “0”, “1” is stored as the group ID 115b, “1500” is stored in the number 115c of bytes to be used for the threshold, “2280” is stored as the data-arrival interval 115d which is used for the threshold, and “5.8” is stored as the threshold 115e.

As illustrated in FIG. 8, a statistical information table 116 stores a number 116b of measured bytes and a measurement time interval 116c in association with a connection ID 116a. The connection ID 116a is an index number which is assigned to each connection. The number 116b of measured bytes is the sum of packet sizes of the measured consecutive packets. The measurement time interval 116c is the sum of arrival time intervals between packets for the measured consecutive packets.

As an example, when the connection ID 116a is “0”, “3000” is stored as the number 116b of measured bytes, and “240” is stored as the measurement time interval 116c.

[Operational Flowchart of Packet Analysis Process]

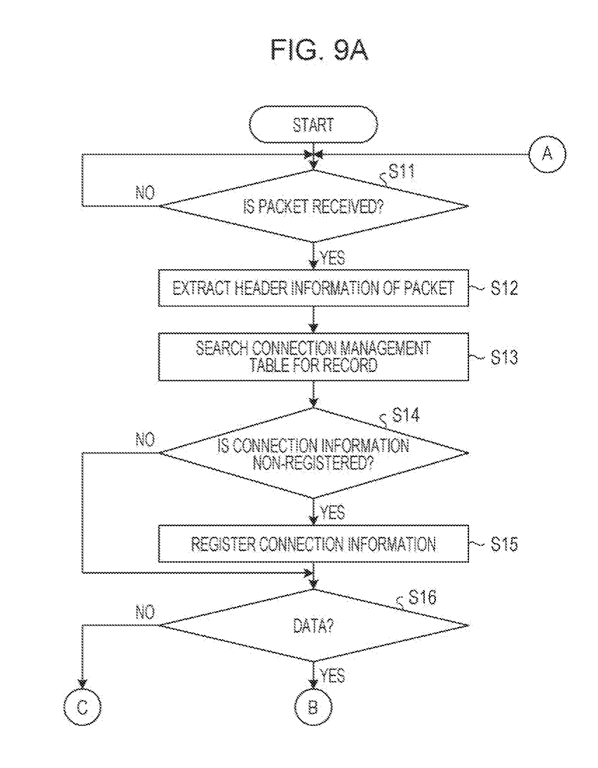

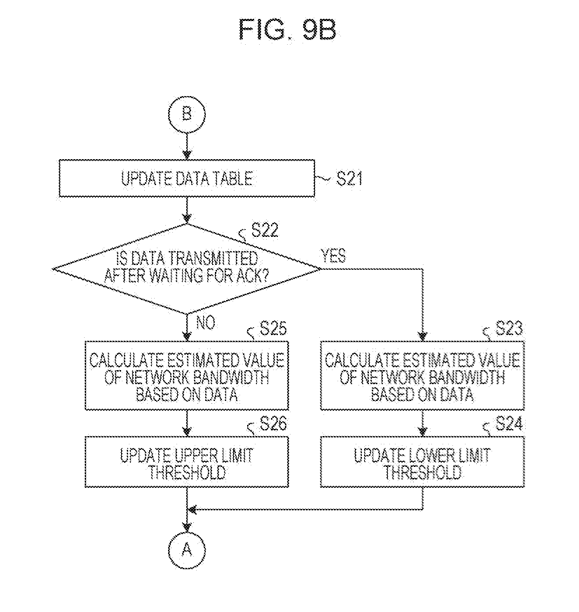

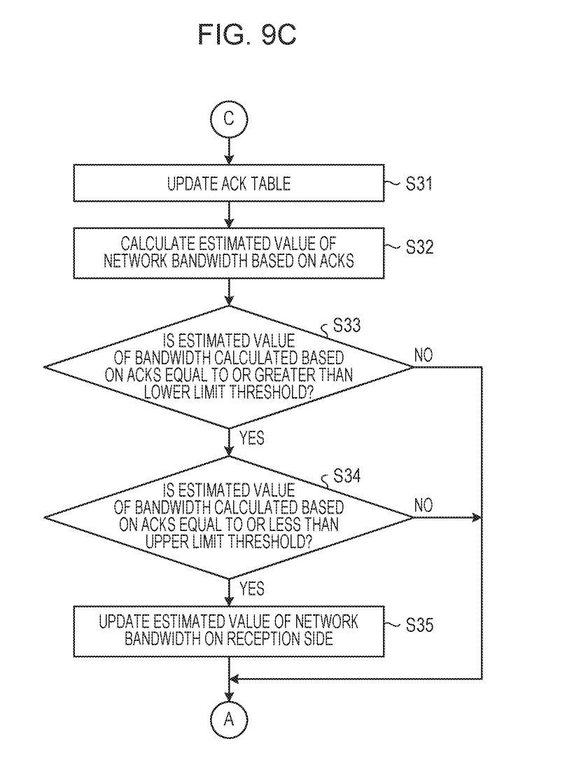

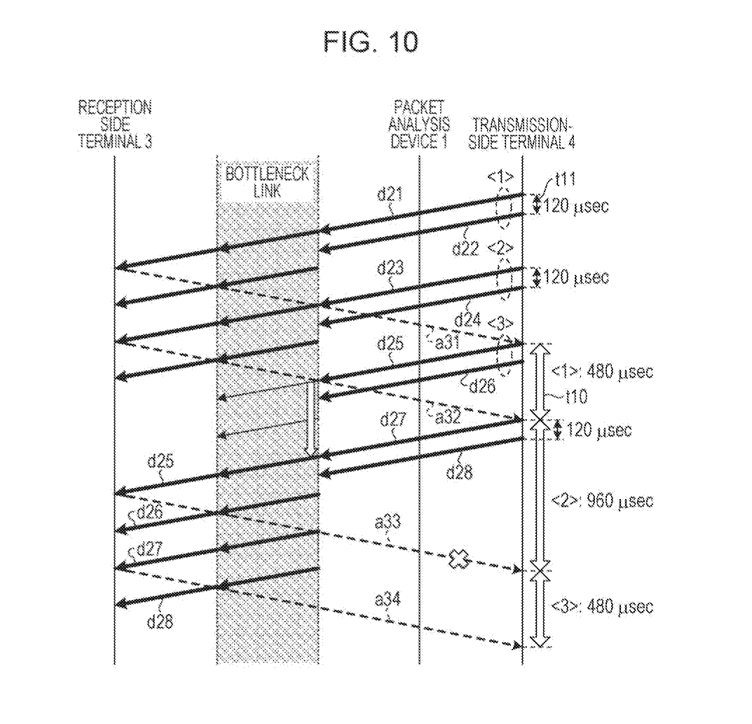

Subsequently, an operational flowchart illustrating a packet analysis process according to the embodiment will be described with reference to FIGS. 9A to 9C. FIG. 9A is a view illustrating an operational flowchart illustrating the packet analysis process according to the embodiment. FIG. 9B is an operational flowchart illustrating a process performed when a data packet is received. FIG. 9C is an operational flowchart illustrating a process performed when an ACK packet is received. Here, it is assumed that the number of consecutive packets is two.

As illustrated in FIG. 9A, the communication interface 122 determines whether or not a packet is received (step S11). When it is determined that the packet is not received (step S11; No), the communication interface 122 repeats a determination process until the packet is received.

In contrast, when it is determined that the packet is received (step S11; Yes), the connection management unit 123 extracts, as connection information, the header information of the received packet (step S12). For example, the connection management unit 123 extracts an IP address of a transmission source and an IP address of a destination from an IP header. The connection management unit 123 extracts a port number of the transmission source, a port number of the destination, a sequence number, an ACK number (acknowledgment number), a packet length, and the like from a TCP header.

Further, the connection management unit 123 searches information stored in the connection management table 111 for a record corresponding to the currently received connection information (step S13). Here, the connection information includes an IP address of the transmission source, a port number of the transmission source, an IP address of the destination and a port number of the destination. For example, the connection management unit 123 searches the connection management table 111 for a target record by using the connection information as a search condition. In the case, it is assumed that connection information is the same even when information of the transmission source and information of the transmission destination are exchanged.

Further, the connection management unit 123 determines whether or not the connection information is non-registered as a result of the search (step S14). When it is determined that the connection information is not non-registered (step S14; No), the connection management unit 123 proceeds to step S16.

In contrast, when it is determined that the connection information is non-registered (step S14; Yes), the connection management unit 123 registers the connection information in the connection management table 111 (step S15). For example, the connection management unit 123 adds the IP address (transmission source IP 111b) and the port number (transmission source port 111c) of the transmission source to a new connection ID (connection ID 111a). In addition, the connection management unit 123 adds the IP address (transmission destination IP 111d) and the port number (transmission destination port 111e) of the destination to the same record. Further, the connection management unit 123 proceeds to step S16.

In step S16, the connection management unit 123 determines whether or not the packet is DATA (step S16). For example, the connection management unit 123 determines that the packet is an ACK when the packet length is 0 and determines that the packet is DATA when the packet length is larger than 0, with reference to the packet length of the TCP header.

When it is determined that the packet is DATA (step S16; Yes), the connection management unit 123 proceeds to step S21 so as to proceed to a process performed when the data packet is received. In contrast, when it is determined that the packet is not DATA (step S16; No), that is, when the packet is an ACK, the connection management unit 123 proceeds to step S31 so as to proceed to a process performed when the ACK packet is received.

[Operational Flowchart Illustrating Process Performed when Data Packet is Received]

As illustrated in FIG. 9B, in step S21, when it is determined that the received packet is DATA, the connection management unit 123 adds the DATA information of the DATA to the DATA table 113 (step S21). The added information includes, for example, a connection ID (connection ID 113a), an ID of the received DATA (data ID 113b), a sequence number (Seq number 113c), a packet length (packet length 113d), and a DATA arrival time to an observation point (arrival time 113e). The observation point means the packet analysis device 1.

The cross traffic determination unit 124 determines whether or not the received DATA is DATA transmitted after waiting for the ACK, by using the DATA table 113 and the ACK table 114 (step S22). For example, when the sequence number (Seq number 113c) of the received DATA is the same as the acknowledgment number (ACK number 114c) of a newly received ACK, the cross traffic determination unit 124 determines that the received DATA is DATA transmitted after waiting for the ACK. In contrast, when the sequence number (Seq number 113c) of the received DATA is not the same as the acknowledgment number (ACK number 114c) of an ACK which is most recently received, the cross traffic determination unit 124 determines that the received DATA is not DATA transmitted after waiting for the ACK. That is, it is determined that the received packet is consecutively transmitted DATA. Meanwhile, the determination process is not limited thereto, and the determination may be performed by comparing the arrival time 113e of the received DATA and the arrival time 114d of the ACK which is most recently received.

When it is determined that the received DATA is DATA which transmitted after waiting for the ACK (step S22; Yes), the cross traffic determination unit 124 calculates an estimated value of the network bandwidth, in the following way, based on the DATA (step S23). That is, the cross traffic determination unit 124 calculates a lower limit threshold by using an arrival interval between pieces of DATA which are respectively transmitted after waiting for an ACK. For example, the cross traffic determination unit 124 acquires an arrival time 113e of a first piece of DATA that has been received, by using the DATA table 113. The cross traffic determination unit 124 acquires an arrival time 113e of a second piece of DATA which is transmitted after waiting for an ACK received immediately before, by using the DATA table 113 and the ACK table 114. Further, the cross traffic determination unit 124 calculates an arrival interval t1 between arrival times of the first and second pieces of DATA. In addition, the cross traffic determination unit 124 acquires an arrival time 113e of a third piece of DATA that has been consecutively transmitted between the two ACKs, by using the DATA table 113 and the ACK table 114. Further, the cross traffic determination unit 124 calculates an arrival interval t2 between the arrival time 113e of the second piece of DATA, which is transmitted after waiting for the ACK received immediately before, and the arrival time 113e of the third piece of DATA that has been consecutively transmitted. Further, the cross traffic determination unit 124 calculates a data-arrival interval of DATA by subtracting the arrival interval t2 from the arrival interval t1. Further, the cross traffic determination unit 124 calculates the estimated value of the network bandwidth by substituting the calculated data-arrival interval of DATA and the size of the first piece of DATA for Equation (1).

The cross traffic determination unit 124 updates the lower-limit threshold in the threshold table 115 with the calculated estimated value of the network bandwidth (step S24). Further, the cross traffic determination unit 124 proceeds to step S11 so as to perform a process for a subsequent packet.

In contrast, when it is determined that the received piece of DATA is not the DATA transmitted after waiting for the ACK (step S22; No), the cross traffic determination unit 124 calculates an estimated value of the network bandwidth, in the following way, based on the DATA (step S25). That is, cross traffic determination unit 124 calculates an upper-limit threshold by using an arrival interval between consecutively transmitted pieces of DATA. For example, the cross traffic determination unit 124 acquires an arrival time 113e of a first piece of DATA that has been received. The cross traffic determination unit 124 acquires an arrival time 113e of a second piece of DATA which is received immediately before the first piece of DATA, by using the DATA table 113. Further, the cross traffic determination unit 124 calculates the arrival interval between the first and second pieces of DATA, based on the arrival times of the first and second pieces of DATA. Further, the cross traffic determination unit 124 calculates the estimated value of the network bandwidth by substituting the calculated arrival interval between the first and second pieces of DATA and the size of the first piece of DATA for Equation (1).

The cross traffic determination unit 124 updates the upper-limit threshold in the threshold table 115 with the calculated estimated value of the network bandwidth (step S26). Further, the cross traffic determination unit 124 proceeds to step S11 so as to perform a process for a subsequent packet.

[Flowchart Illustrating Process Performed when ACK Packet is Recieved]

As illustrated in FIG. 9C, in step S31, when it is determined that the received packet is an ACK, the connection management unit 123 adds ACK information of the ACK to the ACK table 114 (step S31). The added information includes, for example, a connection ID (connection ID 114a), an ID of the received ACK (ACK ID 114b), an ACK number (ACK number 114c), and an ACK arrival time to an observation point (arrival time 114d). The observation point means the packet analysis device 1.

The cross traffic determination unit 124 calculates an estimated value of the network bandwidth, based on the received ACK (step S32). For example, the cross traffic determination unit 124 calculates an arrival interval between the arrival time 114d of a first ACK which has been most recently received, and the arrival time 114d of a second ACK which was received immediately before, by using the ACK table 114. The cross traffic determination unit 124 acquires the packet length 113d of DATA which is transmitted between the first and second ACKs, by using the DATA table 113 and the ACK table 114. Further, the cross traffic determination unit 124 calculates the estimated value of the network bandwidth by substituting the arrival interval between the first and second ACKs and the sizes of pieces of DATA transmitted between the first and second ACKs for Equation (1).

The cross traffic determination unit 124 determines whether or not the estimated value of the network bandwidth, which is calculated based on the first and second ACKs, is equal to or greater than the lower-limit threshold, by using the threshold table 115 (step S33). When it is determined that the estimated value of the network bandwidth, which is calculated based on the first and second ACKs, is not equal to or greater than the lower-limit threshold (step S33; No), the cross traffic determination unit 124 determines that the first ACK, which has been most recently received, is an ACK affected by the cross traffic. Further, the cross traffic determination unit 124 determines that the first ACK is a packet which is not desired to measure the network bandwidth, and proceeds to step S11.

In contrast, when it is determined that the estimated value of the network bandwidth, which is calculated based on the first and second ACKs, is equal to or greater than the lower-limit threshold (step S33; Yes), the cross traffic determination unit 124 performs the following process. That is, the cross traffic determination unit 124 determines whether or not the estimated value of the network bandwidth, which is calculated based on the first and second ACKs, is equal to or less than the upper-limit threshold (step S34). When it is determined that the estimated value of the network bandwidth, which is calculated based on the first and second ACKs, is not equal to or less than the upper-limit threshold (step S34; No), the cross traffic determination unit 124 determines that the first ACK, which has been most recently received, is an ACK which is affected by the cross traffic. Further, the cross traffic determination unit 124 determines that the first ACK is a packet which is not desired to measure the network bandwidth, and proceeds to step S11.

In contrast, when it is determined that the estimated value of the network bandwidth, which is calculated based on the first and second ACKs, is equal to or less than the upper-limit threshold (step S34; Yes), the bandwidth estimation unit 125 performs the following process. That is, the bandwidth estimation unit 125 updates the estimated value of the network bandwidth on the reception-side to the estimated value of the network bandwidth which is calculated based on the first and second ACKs (step S35). Further, the bandwidth estimation unit 125 proceeds to step S11 so as to perform a process for a subsequent packet.

[Detailed Example of Packet Analysis Process]

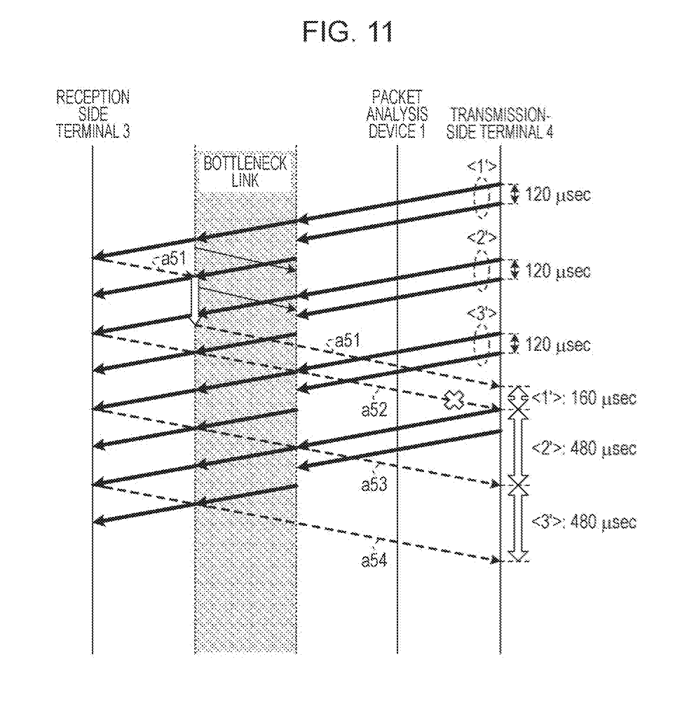

Next, a detailed example of the packet analysis process according to the embodiment will be described with reference to FIGS. 10 and 11. FIG. 10 is a view illustrating the detailed example of the packet analysis process when the ACK interval is lengthened. FIG. 11 is a view illustrating the detailed example of the packet analysis process when the ACK interval is shortened. In FIGS. 10 and 11, it is assumed that a transmission-side network bandwidth is 100 Mbps and a reception-side network bandwidth is 50 Mbps. It is also assumed that the size of each DATA is 1500 bytes and ACKs are replied to two DATA.

[Detailed Example of Packet Analysis Process Performed when ACK Interval is Lengthened]

As illustrated in FIG. 10, there is a case in which, since DATA d25 and d26 are affected by the cross traffic, the interval between an ACK a33 which is replied to the DATA d25 and d26, and an ACK a32 which is replied immediately before the ACK a33, is lengthened.

For example, when DATA d27 is received, the packet analysis device 1 calculates the lower-limit threshold, in the following way, by using an data-arrival interval of DATA since the DATA d27 is a piece of DATA which has been transmitted after waiting for the ACK a32. That is, the packet analysis device 1 calculates an arrival interval between the two pieces of DATA d25 and d27 which have been respectively transmitted after waiting for the ACK a32 and the ACK a31 immediately before the ACK a32. The arrival interval between the two pieces of DATA d25 and d27 is an interval indicted by symbol t10. The packet analysis device 1 calculates a data-arrival interval of DATA, by subtracting an arrival interval between consecutive DATA d25 and d26 which were sent between the ACKs a32 and a31, from the calculated arrival interval, where the arrival interval between the consecutive DATA d25 and d26 is an interval indicated by symbol t11. The packet analysis device 1 calculates the network bandwidth by substituting the calculated data-arrival interval of DATA and the size of the DATA 27 for Equation (1), and sets the calculated network bandwidth to the lower-limit threshold.

Here, it is assumed that an arrival interval between the DATA d25 and d27 is 480 μs and an arrival interval between the consecutive DATA d25 and d26 is 120 μs. In this case, the packet analysis device 1 calculates the lower-limit threshold as in Equation (2) below.

lower-limit threshold=8 bits×1500 bytes/(480 μs−120 μs)=33.33 Mbps Equation (2)

Subsequently, when DATA d28 is received, the packet analysis device 1 calculates the upper-limit threshold, in the following way, by using an arrival interval between the consecutively transmitted pieces of DATA since the DATA d28 is not DATA transmitted after waiting for the ACK a32 and is consecutively transmitted DATA. That is, the packet analysis device 1 calculates an arrival interval between the consecutive DATA d27 and d28. The packet analysis device 1 calculates a network bandwidth, by substituting the calculated arrival interval between the consecutive pieces of DATA and the size of the DATA d28 for Equation (1), and sets the calculated network bandwidth to the upper-limit threshold.

Here, it is assumed that the arrival interval between the consecutive DATA d27 and d28 is 120 μs. In this case, the packet analysis device 1 calculates the upper-limit threshold as in Equation (3) below.

upper-limit threshold=8 bits×1500 bytes/120 μs=100 Mbps Equation (3)

When the ACK a33 is received, the packet analysis device 1 calculates an estimated value of the network bandwidth, based on the received ACK a33 as below. That is, the packet analysis device 1 calculates the estimated value of the network bandwidth, by substituting the arrival interval between the ACK a33 and the ACK a32 which is received immediately before, and the sizes of the DATA d27 and d28 for Equation (1).

Here, it is assumed that the arrival interval between the ACK a33 and the ACK a32 which is received immediately before, is 960 μs. In this case, the packet analysis device 1 calculates the estimated value of the network bandwidth based on the received ACK a33 as in Equation (4) below.

network bandwidth of <2>=8 bits×(2×1500 bytes)/960 μs=25 Mbps Equation (4)

Further, the packet analysis device 1 determines whether or not the estimated value of the network bandwidth, which is calculated based on the ACK a33, is equal to or greater than the lower-limit threshold (33.33 Mbps) and equal to or less than the upper-limit threshold (100 Mbps). Here, the estimated value of the network bandwidth, which is calculated based on the ACK a33, is 25 Mbps. Therefore, it is determined that the estimated value of the network bandwidth is not a value that is equal to or greater than the lower-limit threshold (33.33 Mbps) and equal to or less than the upper-limit threshold (100 Mbps). Here, the packet analysis device 1 determines that the ACK a33 is an ACK affected by the cross traffic. Therefore, the packet analysis device 1 determines the ACK a33 as a packet which is not desired to measure the network bandwidth.

When the ACK a32 is received, the packet analysis device 1 calculates an estimated value of the network bandwidth based on the received ACK a32. Here, it is assumed that the arrival interval between the ACK a32 and the ACK a31 which is received immediately before, is 480 μs. In this case, the packet analysis device 1 calculates the estimated value of the network bandwidth, based on the ACK a32, as in Equation (5) below.

network bandwidth of <1>=8 bits×(2×1500 bytes)/480 μs=50 Mbps Equation (5)

Further, the packet analysis device 1 determines whether or not the estimated value of the network bandwidth, which is calculated based on the ACK a32, is equal to or greater than the lower-limit threshold (33.33 Mbps) and is equal to or less than the upper-limit threshold (100 Mbps). Here, the estimated value of the network bandwidth, which is calculated based on the ACK a32, is 50 Mbps. Therefore, it is determined that the estimated value of the network bandwidth is equal to or greater than the lower-limit threshold (33.33 Mbps) and is equal to or less than the upper-limit threshold (100 Mbps). Therefore, the packet analysis device 1 determines that the ACK a32 is not an ACK affected by the cross traffic. Therefore, the packet analysis device 1 calculates the estimated value of the network bandwidth, based on the ACK a32, and sets the estimated value of the network bandwidth on the reception-side. Here, the estimated value of the network bandwidth on the reception-side is calculated to 50 Mbps as in Equation (5).

When an ACK a34 is received, the packet analysis device 1 calculates an estimated value of the network bandwidth, based on the received ACK a34. Here, it is assumed that an arrival interval between the ACK a34 and the ACK a33 which is received immediately before, is 480 μs. In this case, the packet analysis device 1 calculates the estimated value of the network bandwidth, based on the received ACK a34, as in Equation (6).

network bandwidth of <3>=8 bits×(2×1500 bytes)/480 μs=50 Mbps Equation (6)

Further, the packet analysis device 1 determines whether the estimated value of the network bandwidth, which is calculated based on the ACK a34, is equal to or greater than the lower-limit threshold (33.33 Mbps) and is equal to or less than the upper-limit threshold (100 Mbps). Here, the estimated value of the network bandwidth, which is calculated based on the ACK a34, is 50 Mbps. Therefore, it is determined that the estimated value of the network bandwidth is a value that is equal to or greater than the lower-limit threshold (33.33 Mbps) and is equal to or less than the upper-limit threshold (100 Mbps). Here, the packet analysis device 1 determines that the ACK a34 is not an ACK affected by the cross traffic. Therefore, the packet analysis device 1 calculates the estimated value of the network bandwidth, based on the ACK a32 and the ACK a34, and sets the estimated value of the network bandwidth on the reception-side. Here, the packet analysis device 1 calculates the estimated value of the network bandwidth on the reception-side as in Equation (7) below.

The estimated value of the network bandwidth on the reception-side=8 bits×(4×1500 bytes)/2×480 μs=50 Mbps Equation (7)

[Detailed Example of Packet Analysis Process when ACK Interval is Shortened]

FIG. 11 illustrates a case in which, since an ACK a51 is affected by cross traffic, the ACK interval between the ACK a51 and an ACK a52 is shortened.

For example, as shown in FIG. 10, when the packet analysis device 1 receives a piece of DATA and the piece of DATA is DATA transmitted after waiting for the ACK, the packet analysis device 1 calculates a lower-limit threshold by using a data-arrival interval of DATA. Here, it is assumed that the packet analysis device 1 calculates the lower-limit threshold as 33.33 Mbps, as shown in Equation (2).

Subsequently, when the packet analysis device 1 receives a piece of DATA and the piece of DATA is DATA which is not transmitted after waiting for the ACK and which is consecutively transmitted, the packet analysis device 1 calculates an upper-limit threshold by using an arrival interval between the consecutively transmitted pieces of DATA. Here, it is assumed that the arrival interval between the consecutive pieces of DATA is 120 μs. In this case, the packet analysis device 1 calculates the upper-limit threshold as in Equation (8) below.

upper-limit threshold=8 bits×1500 bytes/120 μs=100 Mbps Equation (8)

Subsequently, when an ACK a52 is received, the packet analysis device 1 calculates an estimated value of the network bandwidth, based on the received ACK a52, as below. That is, the packet analysis device 1 calculates the estimated value of the network bandwidth by substituting the arrival interval between the ACK a52 and the ACK a51 which has been received immediately before, and the sizes of the two DATA for Equation (1).

Here, it is assumed that the arrival interval between the ACK a52 and the ACK a51 which has been received immediately before, is 160 μs (<1′>). In this case, the packet analysis device 1 calculates the estimated value of the network bandwidth, based on the received ACK a52, as in Equation (9) below.

network bandwidth of <15=8 bits×(2×1500 bytes)/160 μs=150 Mbps Equation (9)

Further, the packet analysis device 1 determines whether or not the estimated value of the network bandwidth, which is calculated based on the ACK a52, is equal to or greater than the lower-limit threshold (33.33 Mbps) and is equal to or less than the upper-limit threshold (100 Mbps). Here, since the estimated value of the network bandwidth, which is calculated based on the ACK a52, is 150 Mbps, it is determined that the estimated value of the network bandwidth is not a value that is equal to or less than the upper-limit threshold (100 Mbps). Further, the packet analysis device 1 determines that the ACK a52 is an ACK affected by the cross traffic. Therefore, the packet analysis device 1 determines that the ACK a52 is a packet which is not desired to measure the network bandwidth.

In addition, when an ACK a53 is received, the packet analysis device 1 calculates an estimated value of the network bandwidth, based on the received ACK a53. Here, it is assumed that an arrival interval between the ACK a53 and the ACK a52 which is received immediately before, is 480 μs. In this case, the packet analysis device 1 calculates the estimated value of the network bandwidth, based on the received ACK a53, as in Equation (10) below.

network bandwidth of <25=8 bits×(2×1500 bytes)/480 μs=50 Mbps Equation (10)

Further, the packet analysis device 1 determines whether or not the estimated value of the network bandwidth, which is calculated based on the ACK a53, is equal to or greater than the lower-limit threshold (33.33 Mbps) and is equal to or less than the upper-limit threshold (100 Mbps). Here, since the estimated value of the network bandwidth, which is calculated based on the ACK a53, is 50 Mbps, it is determined that the estimated value of the network bandwidth is a value that is equal to or greater than the lower-limit threshold and is equal to or less than the upper-limit threshold. Here, the packet analysis device 1 determines that the ACK a53 is not an ACK affected by the cross traffic. Therefore, the packet analysis device 1 calculates the estimated value of the network bandwidth, based on the ACK a53, and sets the calculated estimated value of the network bandwidth to the estimated value of the network bandwidth on the reception-side. Here, the estimated value of the network bandwidth on the reception side is calculated to 50 Mbps as in Equation (10).

In addition, when an ACK a54 is received, the packet analysis device 1 calculates an estimated value of the network bandwidth, based on the received ACK a54. Here, it is assumed that an arrival interval between the ACK a54 and the ACK a53 which is received immediately before, is 480 μs. In this case, the packet analysis device 1 calculates the estimated value of the network bandwidth, based on the received ACK a54, as in Equation (11).

network bandwidth of <35=8 bits×(2×1500 bytes)/480 μs=50 Mbps Equation (11)

Further, the packet analysis device 1 determines whether or not the estimated value of the network bandwidth, which is calculated based on the ACK a54, is equal to or greater than the lower-limit threshold (33.33 Mbps) and is equal to or less than the upper-limit threshold (100 Mbps). Here, since the estimated value of the network bandwidth, which is calculated based on the ACK a54, is 50 Mbps, it is determined that the estimated value of the network bandwidth is a value that is equal to or greater than the lower-limit threshold and is equal to or less than the upper-limit threshold. Here, the packet analysis device 1 determines that the ACK a54 is not an ACK affected by the cross traffic. Therefore, the packet analysis device 1 calculates the estimated value of the network bandwidth, based on the ACK a53 and the ACK a54, and sets the estimated value of the network bandwidth to the estimated value of the network bandwidth on the reception side. Here, the packet analysis device 1 calculates the estimated value of the network bandwidth as the estimated value of the network bandwidth on the reception side as in Equation (12) below.

estimated value of network bandwidth on reception side=8 bits×(4×1500 bytes)/2×480 μs=50 Mbps Equation (12)

Therefore, the packet analysis device 1 specifies an ACK affected by the cross traffic and removes the specified ACK when the network bandwidth of the reception-side terminal 3 is measured, and thus it is possible to further accurately measure the network bandwidth of the reception-side terminal 3.

### Advantage of Embodiment

According to the embodiment, the packet analysis device 1 acquires a packet which is communicated between the transmission-side terminal 4 and the reception-side terminal 3 at any spot of the network between the transmission-side terminal 4 and the reception-side terminal 3. The packet analysis device 1 stores the acquired packet in association with an acquisition time. When a bandwidth of data packets, which are transmitted from the transmission-side terminal 4 during a time period from when a first ACK packet transmitted from the reception-side terminal 3 is acquired and until when a second ACK packet, which is a subsequent ACK packet of the first ACK packet, is acquired, is smaller than a bandwidth which is calculated using an acquisition interval between the two data packets which are respectively transmitted after waiting for the first ACK packet and the second ACK packet or is greater than a bandwidth which is calculated using an acquisition interval between two adjacent data packets which include data packets transmitted without waiting for the first ACK packet, the packet analysis device 1 determines that the second ACK packet is a packet which is not desired to measure the bandwidth. According to the configuration, the packet analysis device 1 is able to specify an ACK packet which is not desired to calculate the network bandwidth of the reception-side terminal 3, based on the captured packets, and is able to remove the specified ACK packet. As a result, the packet analysis device 1 is able to further accurately measure the network bandwidth of the reception-side terminal 3.

In addition, according to the embodiment, when a data packet transmitted without waiting for the first ACK packet is acquired, the packet analysis device 1 calculates a bandwidth using an acquisition interval between a data packet transmitted after waiting for the first ACK packet and a data packet transmitted without waiting for the first ACK packet, and updates the lower-limit threshold with the calculated bandwidth. When a data packet transmitted after waiting for the second ACK packet is acquired, the packet analysis device 1 calculates a bandwidth by using an acquisition interval between the two data packets which are respectively transmitted after waiting for the first ACK packet and the second ACK packet, and updates the upper-limit threshold with the calculated bandwidth. When the bandwidth acquired using the acquisition interval between the first ACK packet and the second ACK packet is smaller than the lower-limit threshold or greater than the upper-limit threshold, the packet analysis device 1 determines that the second ACK packet to be a packet which is not desired to measure the bandwidth. According to the configuration, the packet analysis device 1 dynamically updates the threshold whenever a packet arrives, and thus it is possible to automatically change the threshold according to the actions of the packets. In other words, the packet analysis device 1 is able to update the upper-limit threshold and the lower-limit threshold according to the situation of the network. As a result, the packet analysis device 1 is able to accurately specify a packet which is not desired to measure the bandwidth.

[The Others]

Meanwhile, it is possible to realize the packet analysis device 1 by mounting the respective functions of the above-described connection management unit 123, the cross traffic determination unit 124, the bandwidth estimation unit 125, and the like on an information process device, such as known personal computer or a workstation.

In addition, each of the components of the device shown in the drawing does not have to be physically configured as shown in the drawing. That is, the detailed aspects of the division or the integration of a device are not limited to those shown in the drawing, and it is possible to configure all or a part of the components through functional or physical division or integration in an arbitrary unit according to various loads, usages, or the like. For example, the communication interface 122 and the connection management unit 123 may be integrated as one unit. In contrast, the cross traffic determination unit 124 may be divided into a calculation unit that calculates the threshold and a determination unit that determines cross traffic. In addition, the connection management table 111, the analysis information table 112, and the statistical information table 116 may be configured as the external device of the packet analysis device 1, and may be connected to the packet analysis device 1 through a network.

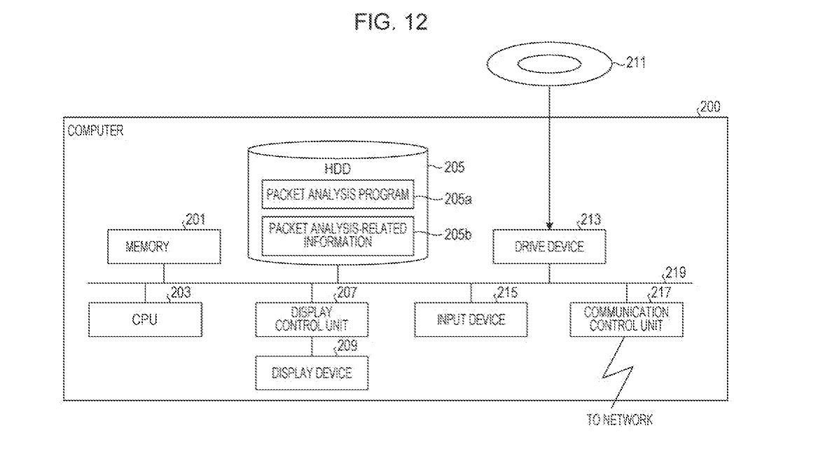

In addition, it is possible to realize the various processes which are described in the embodiment by executing a prepared program in a computer, such as a personal computer or a workstation. Hereinafter, an example of a computer which executes a packet analysis program that realizes the same function as that of the packet analysis device 1 illustrated in FIG. 1 will be described. FIG. 12 is a view illustrating an example of the computer which executes the packet analysis program.

As illustrated in FIG. 12, the computer 200 includes a CPU 203 which executes various operation processes, an input device 215 which receives data input from a user, and a display control unit 207 which controls the display device 209. In addition, the computer 200 includes a drive device 213 which reads a program from a storage medium, and a communication control unit 217 which exchanges data between other computers through a network. In addition, the computer 200 includes a memory 201 which temporally stores various pieces of information, and an HDD 205. Further, the memory 201, the CPU 203, the HDD 205, the display control unit 207, the drive device 213, the input device 215, and the communication control unit 217 are connected to each other through a bus 219.

The drive device 213 is, for example, a device for a removal disk 211. The HDD 205 stores a packet analysis program 205a and packet analysis-related information 205b.

The CPU 203 reads the packet analysis program 205a, deploys the packet analysis program 205a in the memory 201, and executes the packet analysis program 205a as a process. The process corresponds to each of the functional units of the packet analysis device 1. The packet analysis-related information 205b corresponds to the connection management table 111, the analysis information table 112, and the statistical information table 116. Further, for example, the removal disk 211 stores each piece of information such as the packet analysis program 205a.

Meanwhile, the packet analysis program 205a may not be necessarily stored in the HDD 205 from the beginning. For example, the program is stored in a “portable physical medium”, such as a flexible disk (FD), a CD-ROM, a DVD disk, a magneto-optic disk, or an IC card, which is inserted into the computer 200. Further, the computer 200 may read the packet analysis program 205a from among them and execute the packet analysis program 205a.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process, the process comprising:
acquiring a packet which is transmitted between a transmission terminal and a reception terminal, at any spot of a network between the transmission terminal and the reception terminal;
storing the acquired packet in association with a time at which the packet has been acquired; and
when a first bandwidth of data packets which are transmitted by the transmission terminal during a time-period from acquisition of a first acknowledgement (ACK)-packet transmitted by the reception terminal to acquisition of a second ACK-packet that is transmitted by the reception terminal subsequently to the first ACK-packet, is smaller than a second bandwidth or greater than a third bandwidth, determining the second ACK-packet to be a packet which is not desired to measure a bandwidth, the second bandwidth being calculated using an acquisition interval between first and second data packets that are transmitted respectively after waiting for the first ACK-packet and the second ACK-packet, the third bandwidth being calculated using an acquisition interval between two adjacent data packets that includes a data packet transmitted without waiting for an ACK-packet.

2. The non-transitory, computer-readable recording medium of claim 1, wherein the process further comprises:
when a data packet that is transmitted without waiting for the first ACK-packet is acquired, calculating a bandwidth by using an acquisition interval between two adjacent data packets that includes a data packet transmitted without waiting for an ACK-packet, and determining the calculated bandwidth to be an upper-limit threshold;
when a data packet that is transmitted after waiting for the second ACK-packet is acquired, calculating a bandwidth by using an acquisition interval between times of acquiring the first and second data packets that are transmitted respectively after waiting for the first ACK-packet and the second ACK-packet, and determining the calculated bandwidth to be a lower-limit threshold; and
when the bandwidth acquired using the acquisition interval between the first ACK-packet and the second ACK-packet is smaller than the lower-limit threshold or larger than the upper-limit threshold, determining that the second ACK-packet to be a packet that is not desired to measure the bandwidth.

3. A packet analysis device comprising:
a processor configured to:
acquire a packet which is transmitted between a transmission terminal and a reception terminal, at any spot of a network between the transmission terminal and the reception terminal,
store, in a memory coupled to the processor, the acquired packet in association with a time at which the packet has been acquired,
when a first bandwidth of data packets which are transmitted by the transmission terminal during a time-period from acquisition of a first acknowledgement (ACK)-packet transmitted by the reception terminal to acquisition of a second ACK-packet that is transmitted by the reception terminal subsequently to the first ACK-packet, is smaller than a second bandwidth or greater than a third bandwidth, determine the second ACK-packet to be a packet which is not desired to measure a bandwidth, the second bandwidth being calculated using an acquisition interval between first and second data packets that are transmitted respectively after waiting for the first ACK-packet and the second ACK-packet, the third bandwidth being calculated using an acquisition interval between two adjacent data packets that includes a data packet transmitted without waiting for an ACK-packet; and
the memory configured to store a packet in association with a time at which the packet has been acquired.

4. A packet analysis method causing a computer to perform a process comprising:
acquiring a packet which is transmitted between a transmission terminal and a reception terminal, at any spot of a network between the transmission terminal and the reception terminal;
storing the acquired packet in association with a time at which the packet has been acquired; and
when a first bandwidth of data packets which are transmitted by the transmission terminal during a time-period from acquisition of a first acknowledgement (ACK)-packet transmitted by the reception terminal to a time of acquiring a second ACK-packet that is transmitted by the reception terminal subsequently to the first ACK-packet, is smaller than a second bandwidth or greater than a third bandwidth, determining the second ACK-packet to be a packet which is not desired to measure a bandwidth, the second bandwidth being calculated using an acquisition interval between first and second data packets that are transmitted respectively after waiting for the first ACK-packet and the second ACK-packet, the third bandwidth being calculated using an acquisition interval between two adjacent data packets that includes a data packet transmitted without waiting for an ACK-packet.
